(19) United States
(12) Patent Application Publication
(10) Pub. No.: US 2024/0153236 A1
(43) Pub. Date: May 9, 2024

(54) IMAGE COMPARISON APPARATUS AND STORAGE MEDIUM OF IMAGE COMPARISON PROGRAM

(71) Applicant: KYOCERA Document Solutions Inc., Osaka (JP)

(72) Inventors: Naoki Takeuchi, Osaka (JP); Yasuhide Sato, Osaka (JP); Rommel Custodio, Osaka (JP); Akira Yuki, Osaka (JP); Daijiro Kitamoto, Osaka (JP)

(21) Appl. No.: 18/501,979

(22) Filed: Nov. 3, 2023

(30) Foreign Application Priority Data
Nov. 7, 2022 (JP) 2022-178055

(51) Int. Cl. G06V 10/75

(52) U.S. Cl. CPC G06V 10/751

(57) ABSTRACT

The image comparison portion calculates a plurality of pixel SSIM values of a first image and a second image and a representative SSIM value which is an overall SSIM value of both images. The image comparison portion identifies one or more count target SSIM values that belong to a specific range below a first threshold value among the plurality of pixel SSIM values when the representative SSIM value is equal to or greater than the first threshold value. The image comparison portion adds up a number of pixels for each level of the one or more count target SSIM values in both images with a weight according to each level of the one or more count target SSIM values to calculate a weighted sum. The image comparison portion determines that the two images do not match when the weighted sum exceeds a second threshold value.

### INCORPORATION BY REFERENCE

This application is based upon and claims the benefit of priority from the corresponding Japanese Patent Application No. 2022-178055 filed on Nov. 7, 2022, the entire contents of which are incorporated herein by reference.

### BACKGROUND

The present disclosure relates to an image comparison apparatus and a storage medium of an image comparison program for comparing two images.

Conventionally, as a method for comparing two images, a method for detecting the difference in pixel values between two images is known.

Also, in order to detect the difference between two documents, two images respectively corresponding to the two documents may be compared.

At least one of the two images may be a read image read from a document by a reading device, such as a scanner or a camera, or an image based on the read image. In this case, there is a risk that differences due to disturbance factors other than the difference between the two documents may be detected between the two images.

The disturbance factors are, for example, differences caused by image reading processing by the reading device. When differences due to the disturbance factors are detected between the two images, it is difficult to detect the difference between the two documents with sufficient accuracy.

Even when at least one of the two images is the read image or an image based on the read image, it is desirable that the difference between the two documents can be detected with sufficient accuracy.

### SUMMARY

An image comparison apparatus of the present disclosure includes an image comparison portion configured to compare a first image with a second image. The image comparison portion calculates a plurality of pixel SSIM values which are SSIM values of all pixels of the first image and the second image and a representative SSIM value which is an overall SSIM value of the first image and the second image. The image comparison portion further determines that the first image and the second image are difference images when the representative SSIM value is less than a first threshold value. The image comparison portion further identifies one or more count target SSIM values that belong to a specific range below the first threshold value among the plurality of pixel SSIM values when the representative SSIM value is equal to or greater than the first threshold value. The image comparison portion further adds up a number of pixels for each level of the one or more count target SS IM values in the first image and the second image with a weight according to each level of the one or more count target SSIM values to calculate a weighted sum. The image comparison portion further determines that the first image and the second image do not match when the weighted sum exceeds a second threshold value.

This configuration improves the accuracy of detecting the difference between two documents corresponding to the first image and the second image when at least one of the first image and the second image is a read image read from a document by a reading device or an image generated based on the read image. In addition, when the first image and the second image are similar to each other but are not substantially identical to each other, the possibility of erroneously determining that the first image and the second image match is reduced.

Another image comparison apparatus of the present disclosure includes an image comparison portion configured to compare a first image with a second image. The image comparison portion calculates a plurality of pixel SSIM values which are SSIM values of all pixels of the first image and the second image and a representative SSIM value which is an overall SSIM value of the first image and the second image. The image comparison portion further determines that the first image and the second image are difference images when the representative SSIM value is less than a first threshold value. The image comparison portion further identifies one or more count target SSIM values that belong to a specific range below the first threshold value among the plurality of pixel SSIM values when the representative SSIM value is equal to or greater than the first threshold value. The image comparison portion further determines that the first image and the second image do not match when a number of pixels corresponding to the one or more count target SSIM values in the first image and the second image exceeds a second threshold value.

This configuration improves the accuracy of detecting the difference between documents corresponding to the first image and the second image when at least one of the first image and the second image is a read image read from a document by a reading device or an image generated based on the read image. In addition, when the first image and the second image are similar to each other but are not substantially identical to each other, the possibility of erroneously determining that the first image and the second image match is reduced.

In the image comparison apparatus of the present disclosure, the image comparison portion may determine that the first image and the second image do not match when the representative SSIM value is less than the first threshold value.

This configuration reduces the possibility of erroneously determining that the first image and the second image match when the first image and the second image are similar not to each other.

In the image comparison apparatus of the present disclosure, the image comparison portion may determine that the first image and the second image match when the representative SSIM value is equal to or greater than the first threshold value and a number of pixels corresponding to the one or more count target SSIM values is equal to or less than the second threshold value.

This configuration reduces the possibility of erroneously determining that the first image and the second image do not match when the first image and the second image are identical or substantially identical,

In the image comparison apparatus of the present disclosure, the image comparison portion may calculate the plurality of pixel SSIM values for all pixels of a first original image including the first image and a second original image including the second image. The image comparison portion may further extract, from the first original image and the second original image, images composed of pixels corresponding to values less than a third threshold value among the plurality of pixel SSIM values as the first image and the second image. The image comparison portion may further determine that the first original image and the second original image do not match when the image comparison portion determines that the extracted first image and the extracted second image do not match.

This configuration reduces the possibility of erroneously determining that the first original image and the second original image match when the first image and the second image are not similar to each other.

A storage medium of an image comparison program of the present disclosure is a medium storing an image comparison program for causing a computer to execute a process executed by the image comparison apparatus.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a configuration of an image comparison apparatus according to a first embodiment of the present disclosure.

FIG. 2 is a flowchart of the main processing of the image comparison apparatus shown in FIG. 1.

FIG. 3 is a flowchart of preprocessing shown in FIG. 2.

FIG. 4 is a flowchart of a shadow removal process shown in FIG. 3.

FIG. 5 is a flowchart of a shadow mask image generation process shown in FIG. 4.

FIG. 6A is an example of a reference image handled in the shadow mask image generation process shown in FIG. 5.

FIG. 6B is an example of a target image handled in the shadow mask image generation process shown in FIG. 5.

FIG. 6C is an example of a difference absolute value image generated in the shadow mask image generation process shown in FIG. 5.

FIG. 7 shows an example of a histogram generated in the shadow mask image generation process shown in FIG. 5.

FIG. 8A shows a first example of the shadow mask image generated based on the histogram shown in FIG. 7.

FIG. 8B shows a second example of the shadow mask image generated based on the histogram shown in FIG. 7.

FIG. 9A shows a shadow reference image generated based on the shadow mask image shown in FIG. 8A and the reference image shown in FIG. 6A.

FIG. 9B shows a shadow target image generated based on the shadow mask image shown in FIG. 8A and the target image shown in FIG. 6B.

FIG. 9C shows a shadow target image whose tone has been matched to the tone of the shadow reference image shown in FIG. 9A.

FIG. 10A shows a shadow reference image generated based on the shadow mask image shown in FIG. 8B and the reference image shown in FIG. 6A.

FIG. 10B shows a shadow target image generated based on the shadow mask image shown in FIG. 8B and the target image shown in FIG. 6B.

FIG. 10C shows a shadow target image whose tone has been matched to the tone of the shadow reference image shown in FIG. 10A.

FIG. 11A shows a non-shadow reference image generated based on the shadow mask images shown in FIG. 8A and FIG. 8B and the reference image shown in FIG. 6A.

FIG. 11B shows a non-shadow target image generated based on the shadow mask images shown in FIG. 8A and FIG. 8B and the target image shown in FIG. 6B.

FIG. 11C shows a non-shadow target image whose tone has been matched to the tone of the non-shadow reference image shown in FIG. 11A.

FIG. 12 shows a target image generated based on the shadow target images shown in FIG. 9C and FIG. 10C and the non-shadow target image shown in FIG. 11C.

FIG. 13 is a flowchart of a blur degree matching process.

FIG. 14 is a flowchart of a first example of image comparison processing.

FIG. 15 shows an example of an image divided into cells in the image comparison processing.

FIG. 16A shows an example of a reference cell image and a target cell image when an area of difference is narrow and the difference in pixel values in the area of difference is large.

FIG. 16B shows an example of the reference cell image and the target cell image when the difference in pixel values in the area of difference is small and the area of difference is wide.

FIG. 17 is a flowchart of an erroneous determination countermeasure process.

FIG. 18A is an example of a histogram showing the frequency of each pixel SSIM value of all the pixels in the reference cell image and the target cell image when there is almost no difference between the reference cell image and the target cell image.

FIG. 18B is an example of a histogram showing the frequency of each pixel SSIM value of all pixels in the reference cell image and the target cell image when the area of difference between the reference cell image and the target cell image is narrow and the difference in pixel values in the area of difference is large.

FIG. 18C is an example of a histogram showing the frequency of each pixel SSIM value of all pixels in the reference cell image and the target cell image when the difference in pixel values in an area of difference between the reference cell image and the target cell image is small and the area of difference is wide.

FIG. 19 is a flowchart of notification processing.

FIG. 20 is a flowchart of a first part of a second example of the image comparison processing.

FIG. 21 is a flowchart of a latter part of the second example of the image comparison processing.

FIG. 22A shows an example of a mask image having a plurality of areas extracted in the second example of the image comparison processing.

FIG. 22B shows an example of a plurality of unit mask images decomposed from the mask image shown in FIG. 22A.

FIG. 23A shows an example of a reference cell image and a target cell image generated in the second example of the image comparison processing.

FIG. 23B shows an example of a cell mask image applied to the reference cell image and the target cell image shown in FIG. 23A.

FIG. 23C shows an example of a reference extracted image and a target extracted image generated by applying the mask image shown in FIG. 23B to the reference cell image and the target cell image shown in FIG. 23A.

FIG. 24 is a flowchart of an erroneous determination countermeasure process.

### DETAILED DESCRIPTION

Hereinafter, embodiments of the present disclosure will be described with reference to the drawings.

### First Embodiment

First, a configuration of an image comparison apparatus according to a first embodiment of the present disclosure will be described.

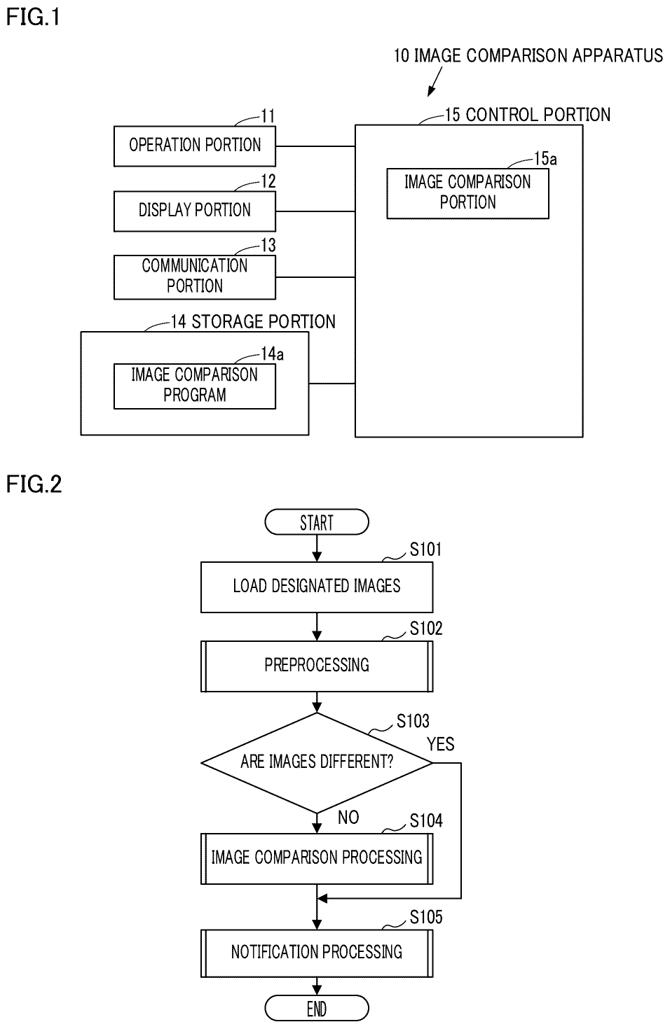

FIG. 1 is a block diagram showing a configuration of an image comparison apparatus 10 according to the present embodiment.

As shown in FIG. 1, the image comparison apparatus 10 includes an operation portion 11, a display portion 12, a communication portion 13, a storage portion 14, and a control portion 15.

The operation portion 11 is an operation device, such as a keyboard or a mouse, through which various operations are input. The display portion 12 is a display device, such a liquid crystal display (LCD), which displays various types of information.

The communication portion 13 is a communication device that communicates with an external apparatus. The communication portion 13 communicates with an external apparatus via a network such as a local area network (LAN) or the Internet, or directly by wire or radio without using a network.

The storage portion 14 is a non-volatile storage device, such as a semiconductor memory or a hard disk drive (HDD), which stores various types of information. The control portion 15 controls the entire image comparison apparatus 10. The image comparison apparatus 10 may be configured by, for example, a single personal computer (PC).

The storage portion 14 stores an image comparison program 14a that implements a process of comparing two images. For example, the image comparison program 14a may be installed in the image comparison apparatus 10 at the manufacturing stage of the image comparison apparatus 10, or may be additionally installed in the image comparison apparatus 10 from an external storage medium such as a universal serial bus (USB) memory. In addition, the image comparison program 14a may be additionally installed in the image comparison apparatus 10 from the network.

The control portion 15 includes, for example, a central processing unit (CPU), a read only memory (ROM), and a random access memory (RAM). The ROM stores programs and various types of data. The RAM is a memory used as a work area of the CPU of the control portion 15.

The CPU of the control portion 15 executes programs stored in the storage portion 14 or the ROM of the control portion 15. The image comparison program 14a is a computer program that causes the CPU to execute preprocessing, image comparison processing, and notification processing, which will be described later.

The control portion 15 executes the image comparison program 14a to implement an image comparison portion 15a that compares two images.

Next, the main processing of the image comparison apparatus 10 will be described.

FIG. 2 is a flowchart of the main processing of the image comparison apparatus 10.

When receiving an image comparison instruction via the operation portion 11 or the communication portion 13, the image comparison portion 15a executes the main processing shown in FIG. 2. The image comparison instruction is an instruction to execute a process of comparing two images.

The image comparison instruction includes information designating a target image and a reference image. The target image is an image to be compared. The reference image is an image to be compared with the target image. The reference image and the target image are images of documents.

For example, the reference image is an image generated on a computer. Alternatively, the reference image may be a read image generated by being read from a document by a reading device such as a scanner. Alternatively, the reference image may be an image generated based on the read image.

The target image is a read image generated by being read from a document by a reading device such as a scanner or a camera. Alternatively, the target image may be an image generated based on the read image. For example, the target image may be a read image which is, after the reference image is printed on a recording medium such as a sheet, read by the reading device from the printed sheet.

As shown in FIG. 2, the image comparison portion 15a loads the reference image and the target image designated in the image comparison instruction (S101).

Next, the image comparison portion 15a performs preprocessing on the reference image and the target image loaded in S101 as preparation for image comparison (S102).

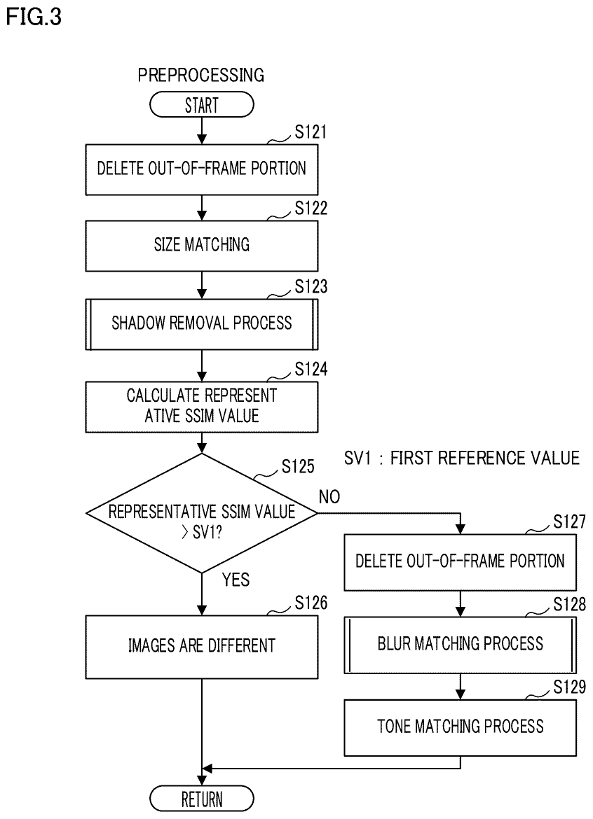

FIG. 3 is a flowchart of the preprocessing in S102 of FIG. 2.

As shown in FIG. 3, for each of the reference image and the target image loaded in S101, the image comparison portion 15a deletes an out-of-frame portion other than a portion corresponding to the recording medium of the image (S121).

For example, when the target image loaded in S101 is the read image, the target image may include the out-of-frame portion. The out-of-frame portion is a portion outside a portion corresponding to a recording medium such as a sheet.

Therefore, in S121, the image comparison portion 15a detects the outer shape of the portion corresponding to the recording medium for each of the reference image and the target image loaded in S101.

Further, the image comparison portion 15a cuts out the inner portion of the detected outer shape from each of the reference image and the target image loaded in S101. The image comparison portion 15a thereby deletes the out-of-frame portion from each of the reference image and the target image.

When the process of S121 is completed, the image comparison portion 15a matches the sizes of the reference image and the target image for which the process of S121 has been executed (S122).

For example, in S122, the image comparison portion 15a extracts feature points from each of the reference image and the target image subjected to the process of S121. Further, the image comparison portion 15a enlarges or reduces at least one of the reference image and the target image based on the extracted feature points so that the sizes of the reference image and the target image match.

In addition, in S122, the image comparison portion 15a may rotate at least one of the reference image and the target image based on the extracted feature points so that the orientations of the reference image and the target image match.

When the process of S122 is completed, the image comparison portion 15a executes a shadow removal process of removing shadows from the target image subjected to the process of S122 (S123).

For example, when the target image is the read image, a shadow of, for example, a camera or a photographer may be included in the target image when the image is captured. Therefore, in the shadow removal process of S123, the image comparison portion 15a performs image processing of a specific algorithm on the target image to remove the shadow from the target image.

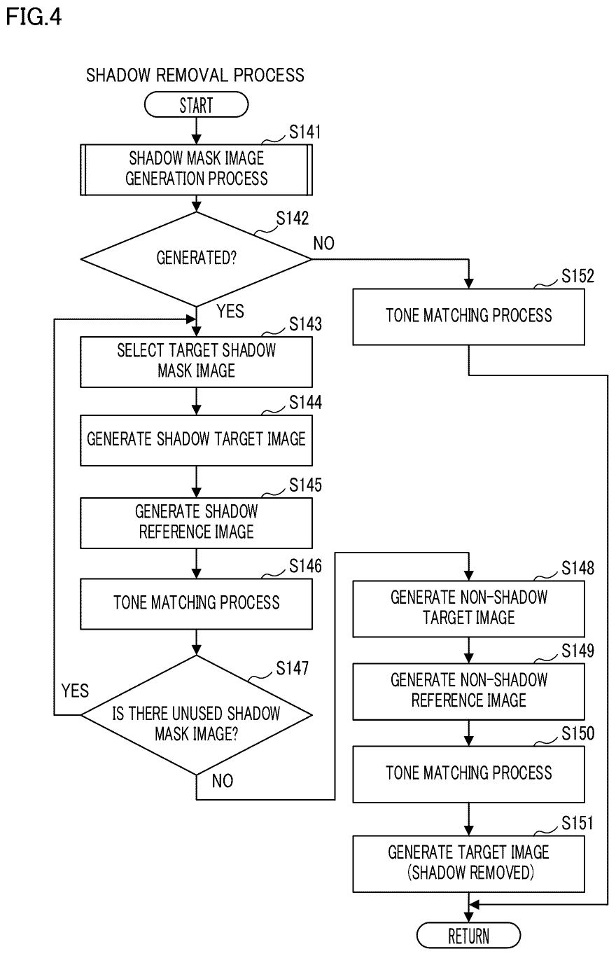

FIG. 4 is a flowchart of an example of the shadow removal process shown in FIG. 3.

As shown in FIG. 4, the image comparison portion 15a executes a shadow mask image generation process of generating a mask image for extracting a shadow portion from the target image (S141). Hereinafter, the image generated by the shadow mask image generation process will be referred to as a shadow mask image.

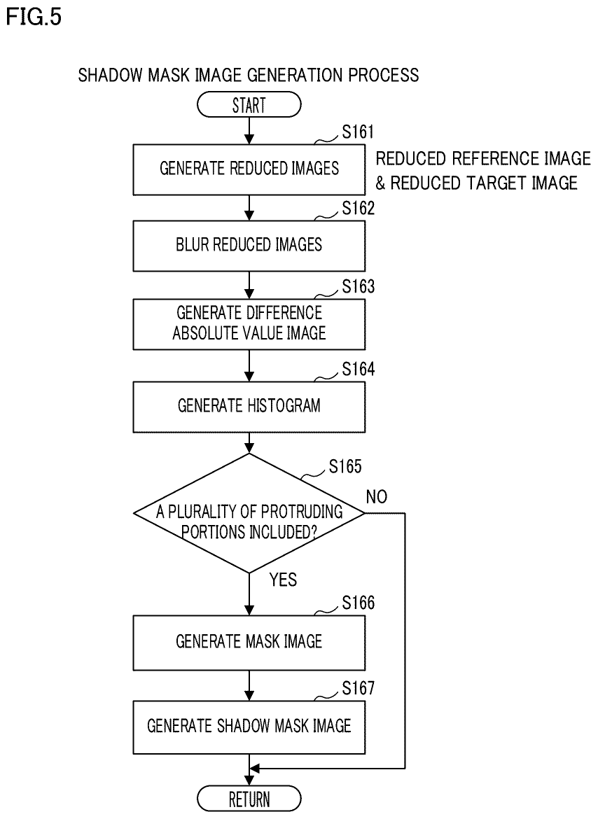

FIG. 5 is a flowchart of the shadow mask image generation process shown in FIG. 4.

As shown in FIG. 5, the image comparison portion 15a generates a reduced reference image and a reduced target image (S161). The reduced reference image is an image obtained by reducing the size of the reference image subjected to the process of S122 to a specific size. The reduced target image is an image obtained by reducing the size of the target image subjected to the process of S122 to the same size as the size of the reduced reference image.

When the process of S161 is completed, the image comparison portion 15a blurs the reduced reference image and the reduced target image generated in S161 (S162). For example, in S162, the image comparison portion 15a executes a specific method such as applying a Gaussian filter to the reduced reference image and the reduced target image. The image comparison portion 15a thereby blurs the reduced reference image and the reduced target image.

When the process of S162 is completed, the image comparison portion 15a generates a difference absolute value image (S163). The difference absolute value image is an image showing an absolute value of the difference in each pixel between the reduced reference image and the reduced target image blurred in S162.

It is noted that the process of S163 is executed on the assumption that the reduced reference image and the reduced target image are grayscale images. Accordingly, if the reduced reference image and the reduced target image are not grayscale images, the image comparison portion 15a converts the reduced reference image and the reduced target image into grayscale images, and then executes the process of S163.

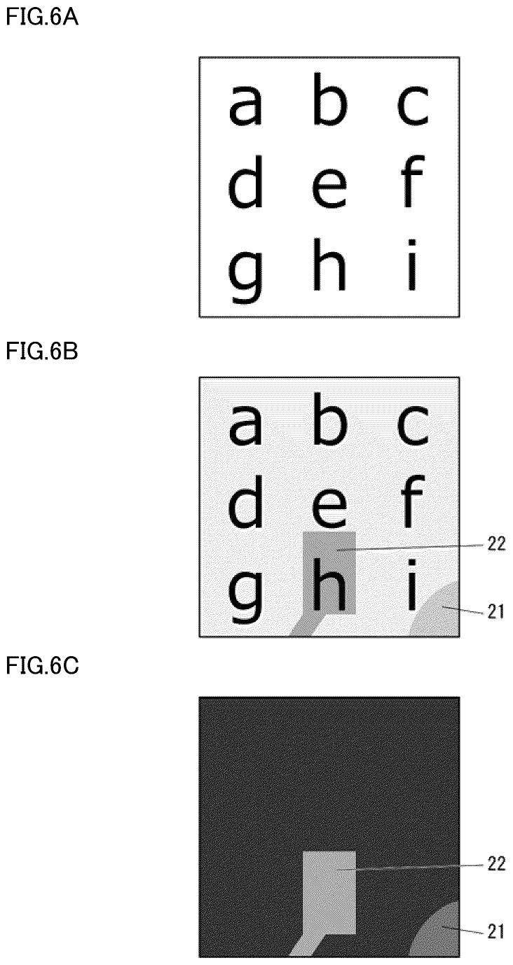

FIG. 6A is an example of the reference image handled in the shadow mask image generation process shown in FIG. 5. FIG. 6B is an example of the target image handled in the shadow mask image generation process shown in FIG. 5. FIG. 6C is an example of the difference absolute value image generated in the shadow mask image generation process shown in FIG. 5.

For example, the difference absolute value image shown in FIG. 6C is generated using the reference image shown in FIG. 6A and the target image shown in FIG. 6B. FIG. 6A shows an example of the reference image subjected to the process of S122. FIG. 6B shows an example of the target image subjected to the process of S122.

In FIG. 6B and FIG. 6C, an area 21 is an area caused by, for example, the shadow of the photographer. In FIG. 6B and FIG. 6C, an area 22 is an area caused by, for example, the shadow of the camera.

As shown in FIG. 5, when the process of S163 is completed, the image comparison portion 15a generates a histogram showing the number of pixels for each luminance of the difference absolute value image generated in S163 (S164).

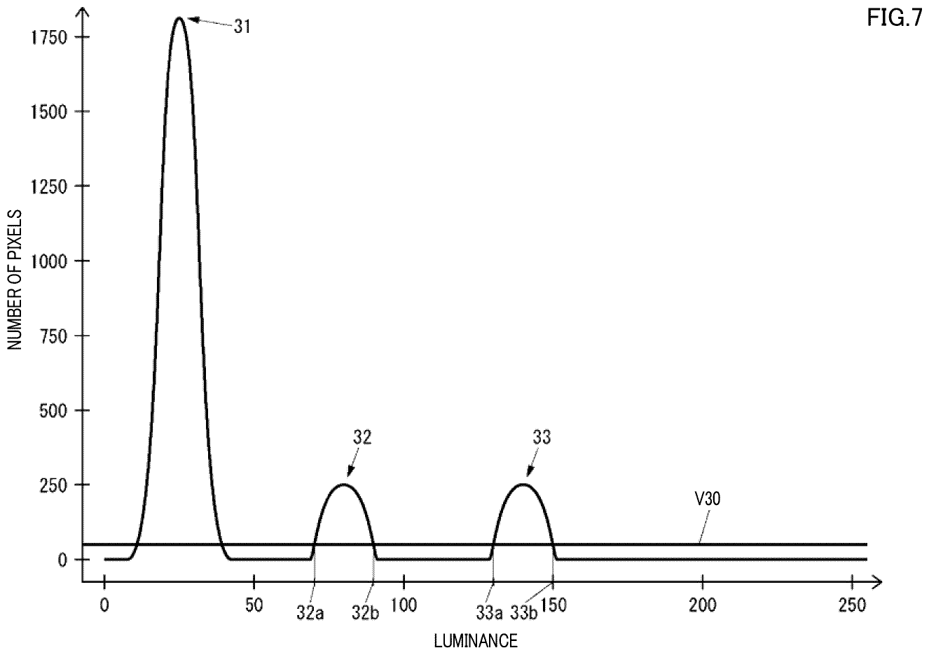

FIG. 7 shows an example of the histogram generated in the shadow mask image generation process.

When the difference absolute value image shown in FIG. 6C is generated in S163, the image comparison portion 15a generates, for example, the histogram shown in FIG. 7 in the process of S164.

The histogram shown in FIG. 7 includes a first protruding portion 31, a second protruding portion 32, and a third protruding portion 33 as protruding portions that are portions where the number of pixels is equal to or greater than a specific threshold value V30. The first protruding portion 31 is a protruding portion with the lowest luminance. The second protruding portion 32 is a protruding portion with higher luminance than the first protruding portion 31. The third protruding portion 33 is a protruding portion with higher luminance than the second protruding portion 32.

The threshold value V30 is, for example, 50. The comparison between the reference image and the target image is performed for the purpose of detecting differences in some characters, for example. Therefore, the luminance of each pixel is likely to be substantially the same in the reduced reference image and the reduced target image subjected to the process of S162 if there is no shadow.

Therefore, the first protruding portion 31 with the lowest luminance represents a difference in luminance between the entire reduced reference image and the entire reduced target image subjected to the process of S162. The second protruding portion 32 and the third protruding portion 33, which have higher luminance than the first protruding portion 31, can be regarded as representing differences in luminance due to shadow influence.

Specifically, the second protruding portion 32 is caused by the influence of the shadow corresponding to the area 21 shown in FIG. 6B. The third protruding portion 33 is caused by the influence of the shadow corresponding to the area 22 shown in FIG. 6B.

As shown in FIG. 5, when the process of S164 is completed, the image comparison portion 15a determines whether or not the histogram generated in S164 includes a plurality of protruding portions with the number of pixels equal to or greater than a specific threshold value (S165).

When the image comparison portion 15a determines that the histogram includes the plurality of protruding portions, the image comparison portion 15a identifies one or more target protruding portions other than the first protruding portion 31 with the lowest luminance among the plurality of protruding portions. Further, the image comparison portion 15a generates a mask image for extracting pixels within a luminance range that constitute each of the target protruding portions (S166). The second protruding portion 32 and the third protruding portion 33 are examples of the target protruding portion.

For example, when the histogram shown in FIG. 7 is generated in the process of S164, the image comparison portion 15a generates a first mask image for extracting the pixels constituting the second protruding portion 32. The first mask image is a mask image for extracting pixels from the lower limit luminance 32a to the upper limit luminance 32b of the luminance range corresponding to the second protruding portion 32.

In addition, the image comparison portion 15a generates a second mask image for extracting the pixels constituting the third protruding portion 33. The second mask image is a mask image for extracting pixels from the lower limit luminance 33a to the upper limit luminance 33b of the luminance range corresponding to the third protruding portion 33.

When the process of S166 is completed, the image comparison portion 15a generates a shadow mask image by enlarging the mask image generated in S166 to the same size as the reference image (S167). The shadow mask image generation process shown in FIG. 5 is thereby completed.

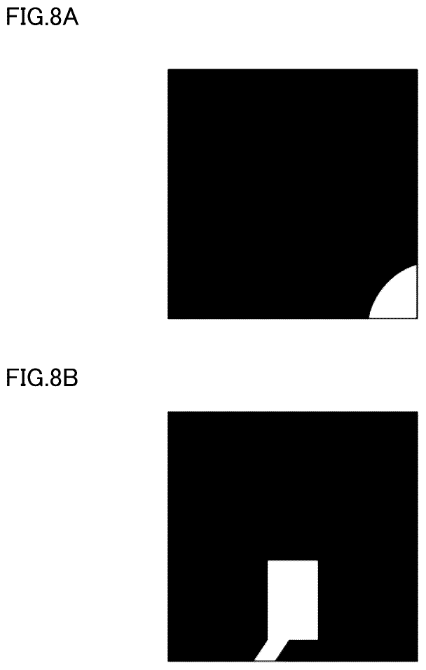

FIG. 8A shows a first example of the shadow mask image generated based on the histogram shown in FIG. 7. FIG. 8B shows a second example of the shadow mask image generated based on the histogram shown in FIG. 7.

For example, let us assume that the difference absolute value image shown in FIG. 6C and the histogram shown in FIG. 7 are generated in S163 and S164. In this case, in the process of S167, the image comparison portion 15a generates, for example, the first shadow mask image shown in FIG. 8A and the second shadow mask image shown in FIG. 8B. The first shadow mask image is the shadow mask image for the second protruding portion 32. The second shadow mask image is the shadow mask image for the third protruding portion 33.

As shown in FIG. 5, when the image comparison portion 15a determines that the histogram generated in S164 does not include the plurality of protruding portions with the number of pixels equal to or greater than the specific threshold value, the image comparison portion 15a terminates the shadow mask image generation process shown in FIG. 5. In this case, the shadow mask image is not generated.

As shown in FIG. 4, when the shadow mask image generation process of S141 is completed, the image comparison portion 15a determines whether or not the shadow mask image was generated in S141 (S142).

When the image comparison portion 15a determines that the shadow mask image was generated, the image comparison portion 15a selects, as a target shadow mask image, one of the shadow mask images generated in S141 that has not yet been used for the masking process (S143).

When the process of S143 is completed, the image comparison portion 15a generates a shadow target image based on the target shadow mask image and the target image subjected to the process of S122 (S144). The shadow target image is an image of the shadow portion in the target image. That is, the image comparison portion 15a executes the masking process on the target image using the target shadow mask image.

When the process of S144 is completed, the image comparison portion 15a generates a shadow reference image based on the target shadow mask image and the reference image subjected to the process of S122 (S145). The shadow reference image is an image of a portion corresponding to the shadow target image in the reference image. That is, the image comparison portion 15a executes the masking process on the reference image using the target shadow mask image.

When the process of S145 is completed, the image comparison portion 15a matches the tone of the shadow target image generated in S144 to the tone of the shadow reference image generated in S145 (S146). In S146, the image comparison portion 15a creates a gamma table that matches the histogram of the shadow target image to the histogram of the shadow reference image. Further, the image comparison portion 15a applies the created gamma table to the shadow target image to match the tone of the shadow target image to the tone of the shadow reference image.

When the process of S146 is completed, the image comparison portion 15a determines whether or not there is an image that has not yet been used for the masking process among the shadow mask images generated in S141 (S147).

When the image comparison portion 15a determines that there is an image that has not yet been used for the masking process among the shadow mask images generated in S141, the image comparison portion 15a executes the process of S143.

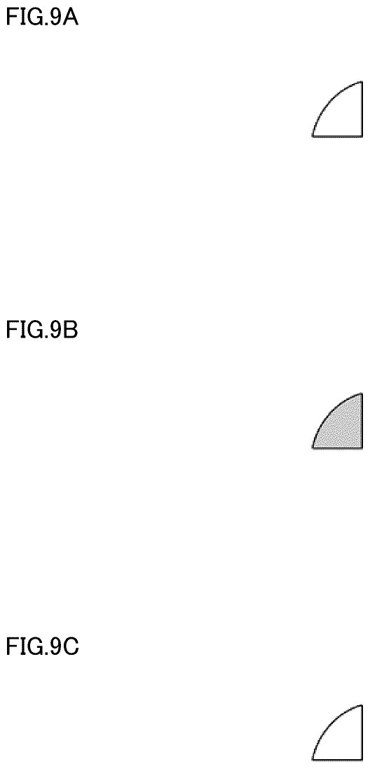

FIG. 9A shows the shadow reference image generated based on the shadow mask image shown in FIG. 8A and the reference image shown in FIG. 6A.

FIG. 9A shows the shadow target image generated based on the shadow mask image shown in FIG. 8A and the target image shown in FIG. 6B. FIG. 9C shows the shadow target image whose tone has been matched to the tone of the shadow reference image shown in FIG. 9A.

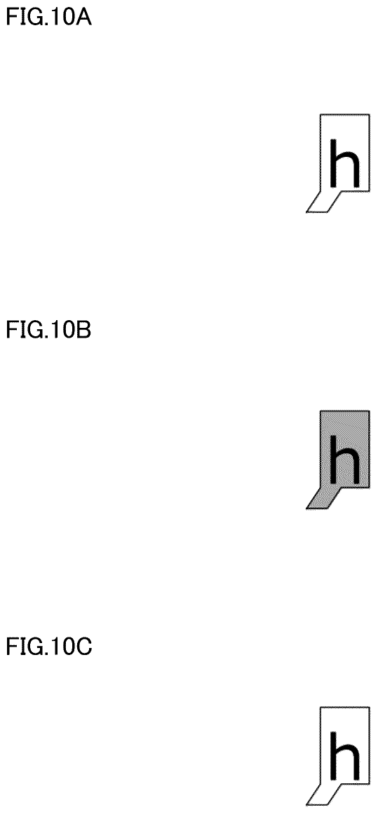

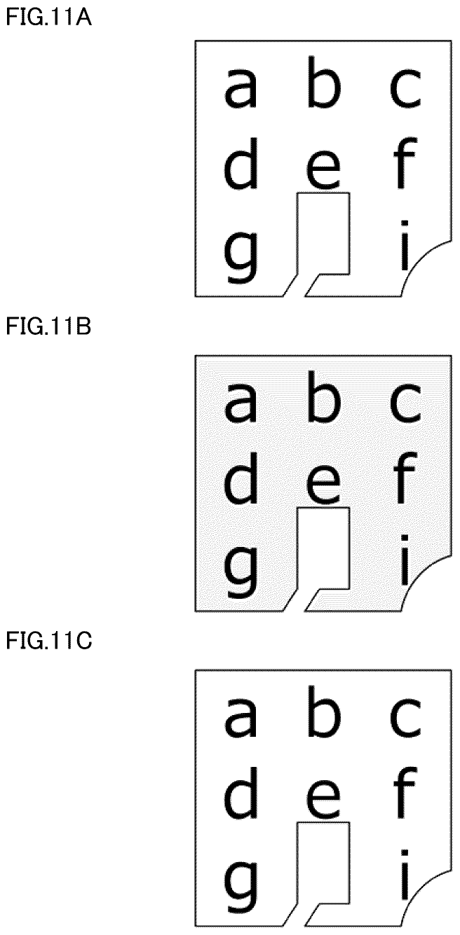

FIG. 10A shows the shadow reference image generated based on the shadow mask image shown in FIG. 8B and the reference image shown in FIG. 6A. FIG. 10B shows the shadow target image generated based on the shadow mask image shown in FIG. 8B and the target image shown in FIG. 6B. FIG. 10C shows the shadow target image whose tone has been matched to the tone of the shadow reference image shown in FIG. 10A.

FIG. 9A to FIG. 9C show images generated based on the reference image shown in FIG. 6A, the target image shown in FIG. 6B, and the shadow mask image shown in FIG. 8A. FIG. 6A and FIG. 6B show the reference image and the target image subjected to the process of S122, respectively.

The image comparison portion 15a generates the shadow target image shown in FIG. 9B in S144, generates the shadow reference image shown in FIG. 9A in S145, and generates the shadow target image shown in FIG. 9C in S146.

FIG. 10A to FIG. 10C show images generated based on the reference image shown in FIG. 6A, the target image shown in FIG. 6B, and the shadow mask image shown in FIG. 8B.

The image comparison portion 15a generates the shadow target image shown in FIG. 10B in S144, generates the shadow reference image shown in FIG. 10A in S145, and generates the shadow target image shown in FIG. 10C in S146.

In S147 of FIG. 4, when the image comparison portion 15a determines that there is no image that has not yet been used for the masking process among the shadow mask images generated in S141, the image comparison portion 15a generates a non-shadow target image (S148).

The image comparison portion 15a generates the non-shadow target image based on all the shadow mask images generated in S141 and the target image subjected to the process of S122. The non-shadow target image is an image of a portion other than the shadow in the target image.

When the process of S148 is completed, the image comparison portion 15a generates a non-shadow reference image based on all the shadow mask images generated in S141 and the reference image subjected to the process of S122 (S149). The non-shadow reference image is an image of a portion corresponding to the non-shadow target image in the reference image.

When the process of S149 is completed, the image comparison portion 15a matches the tone of the non-shadow target image generated in S148 to the tone of the non-shadow reference image generated in S149 (S150).

In S150, the image comparison portion 15a creates a gamma table that matches the histogram of the non-shadow target image to the histogram of the non-shadow reference image. Further, the image comparison portion 15a applies the created gamma table to the non-shadow target image to match the tone of the non-shadow reference image to the tone of the non-shadow target image.

FIG. 11A shows the non-shadow reference image generated based on the shadow mask images shown in FIG. 8A and FIG. 8B and the reference image shown in FIG. 6A. FIG. 11B shows the non-shadow target image generated based on the shadow mask images shown in FIG. 8A and FIG. 8B and the target image shown in FIG. 6B. FIG. 11C shows the non-shadow target image whose tone has been matched to the tone of the non-shadow reference image shown in FIG. 11A.

FIG. 11A to FIG. 11C show images generated based on the reference image shown in FIG. 6A, the target image shown in FIG. 6B, and the shadow mask images shown in FIG. 8A and FIG. 8B. The image comparison portion 15a generates the non-shadow target image shown in FIG. 11B in S148, generates the non-shadow reference image shown in FIG. 11A in S149, and generates the non-shadow target image shown in FIG. 11C in S150.

As shown in FIG. 4, when the process of S150 is completed, the image comparison portion 15a generates a target image from which the shadow has been removed (S151). The image comparison portion 15a removes the shadow in the target image by synthesizing all the shadow target images whose tones have been matched to the tone of the shadow reference image in S146 and the non-shadow target image whose tone has been matched to the tone of the non-shadow reference image in S150.

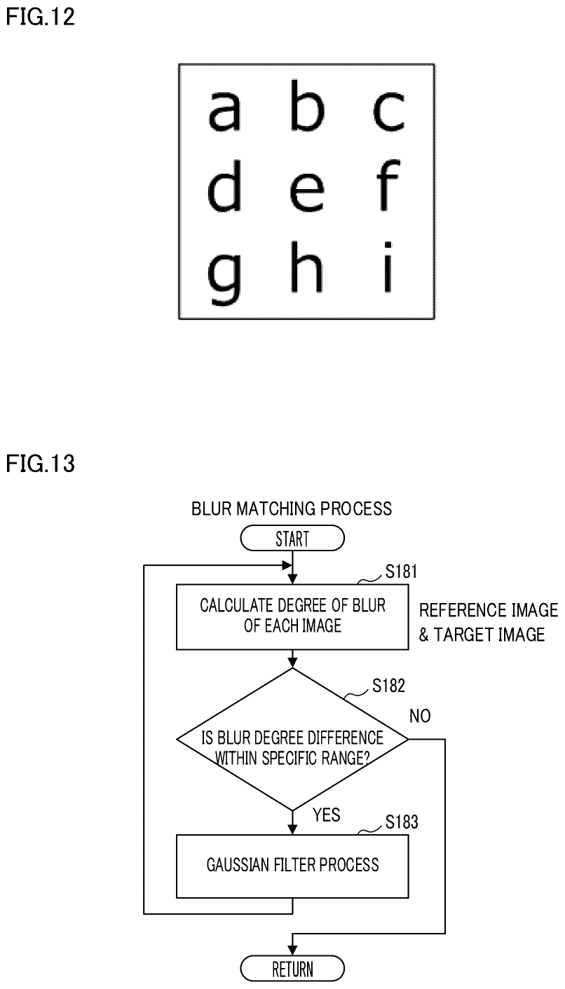

FIG. 12 shows the target image generated based on the shadow target images shown in FIG. 9C and FIG. 10C and the non-shadow target image shown in FIG. 11C.

FIG. 12 shows the target image generated based on the shadow target images shown in FIG. 9C and FIG. 10C and the non-shadow target image shown in FIG. 11C. FIG. 9C and FIG. 10C each show the shadow target image whose tone was matched to the tone of the shadow reference image in S146. FIG. 11C shows the non-shadow target image whose tone was matched to the tone of the non-shadow reference image in S150. In S151, the image comparison portion 15a generates the target image shown in FIG. 12.

As shown in FIG. 4, when the image comparison portion 15a determines that the shadow mask image was not generated in S142, the image comparison portion 15a executes the process of S152. In S152, the image comparison portion 15a matches the tone of the target image subjected to the process of S122 to the tone of the reference image subjected to the process of S122 (S152).

In S152, the image comparison portion 15a creates a gamma table that matches the histogram of the target image to the histogram of the reference image. Further, the image comparison portion 15a applies the created gamma table to the target image to match the tone of the target image to the tone of the reference image.

When the process of S151 or S152 is completed, the image comparison portion 15a terminates the shadow removal process shown in FIG. 4.

As shown in FIG. 3, when the shadow removal process of S123 is completed, the image comparison portion 15a executes the process of S124. In S124, the image comparison portion 15a calculates a representative SSIM value which is an overall structural similarity (SSIM) value of the reference image subjected to the process of S122 and the target image subjected to the process of S123.

That is, in S124, the image comparison portion 15a calculates a plurality of pixel SSIM values which are the SS IM values of all the pixels in the reference image and the target image. Further, the image comparison portion 15a calculates an average value of the plurality of pixel SS IM values as the representative SSIM value.

It is noted that each of the pixel SSIM values is an image evaluation index expressed by the following equation (1):

$$\\ \begin{matrix}SSIM = \frac{( 2 {μ}_{x} {μ}_{y} + {C}_{1} ) ( 2 {σ}_{xy} + {C}_{2} )}{( {μ}_{x}^{{}^{} 2} + {μ}_{y}^{{}^{} 2} + {C}_{1} ) ( {σ}_{x}^{{}^{} 2} + {σ}_{y}^{{}^{} 2} + {C}_{2} )} & ( 1 )\end{matrix}$$

Here, all pixel values in a specific local area centered on a pixel at a target position in each image processed by image comparison portion 15a are referred to as all specific pixel values. In Equation (1), μₓ is an average value of all the specific pixel values in the reference image. μ_{y} is an average value of all the specific pixel values in the target image. σₓ is the standard deviation of all the specific pixel values in the reference image. σ_{y} is the standard deviation of all the specific pixel values in the target image. σ_{xy} is the covariance between all the specific pixel values in the reference image and all the specific pixel values in the target image. c₁ and c₂ are constants. The pixel SSIM values and the representative SSIM value are each a value of 0 or more and 1 or less. The closer the representative SSIM value is to 1, the more similar the two compared images are.

When the process of S124 is completed, the image comparison portion 15a determines whether or not the representative SS IM value calculated in S124 is less than a predetermined first reference value (S125).

When the image comparison portion 15a determines that the representative SSIM value is less than the first reference value, the image comparison portion 15a determines that the reference image and the target image are different images (S126), and terminates the preprocessing shown in FIG. 3.

When the image comparison portion 15a determines that the representative SSIM value is not less than the reference value, the image comparison portion 15a executes the process of S127. In S127, the image comparison portion 15a deletes the out-of-frame portions of the reference image subjected to the process of S122 and the target image subjected to the process of S123.

When the process of S127 is completed, the image comparison portion 15a executes a blur matching process (S128). The blur matching process is a process of reducing the difference in the degree of blur between the reference image and the target image generated in S127 to within a specific range.

For example, when the target image is an image generated by being captured by a camera, shake at the time of image capturing may be reflected in the target image. In addition, an image read from a document sheet by a scanner may reflect shake due to conveyance by an auto document feeder (ADF), for example.

Therefore, in S128, the image comparison portion 15a performs image processing of a specific algorithm on one of the reference image and the target image generated in S127, which has a smaller degree of blur. Thus, the image comparison portion 15a matches the degrees of blur of the reference image and the target image. It is noted that the image comparison portion 15a does not need to completely match the degrees of blur of the reference image and the target image as long as the degrees of blur of the reference image and the target image can be brought close to each other within a specific degree in the blur matching process of S128.

FIG. 13 is a flowchart of the blur matching process shown in FIG. 3.

As shown in FIG. 13, the image comparison portion 15a calculates the degree of blur of each of the reference image and the target image (S181).

Specifically, the image comparison portion 15a performs a Laplacian transform on the reference image to generate a transformed reference image. Further, the image comparison portion 15a calculates the variance value of the transformed reference image as the degree of blur of the reference image. The variance value of the transformed reference image is an example of the variation of the pixel values in the transformed reference image.

The transformed reference image is an image obtained by extracting contours from the reference image. When the degree of blur of the reference image is small, a large number of contours are extracted from the reference image, and the variance value of the transformed reference image is large. Conversely, when the degree of blur of the reference image is large, a small number of contours are extracted from the reference image, and the variance value of the transformed reference image is small.

The above description of the reference image is also true for the degree of blur of the target image. That is, the image comparison portion 15a performs a Laplacian transform on the target image to generate a transformed target image. Further, the image comparison portion 15a calculates the variance value of the transformed target image as the degree of blur of the target image. The variance value of the transformed target image is an example of the variation of the pixel values in the transformed target image.

When the process of S181 is completed, the image comparison portion 15a determines whether or not the blur degree difference, which is the difference between the degrees of blur of the reference image and the target image calculated in S181, is within a specific range (S182).

When the image comparison portion 15a determines that the blur degree difference is not within the specific range, the image comparison portion 15a applies a specific Gaussian filter to one of the reference image and the target image that has a smaller degree of blur (S183). That is, the image comparison portion 15a adds blur to one of the reference image and the target image that has a smaller degree of blur. The process of the Gaussian filter is an example of the process of adding blur.

When the process of S183 is completed, the image comparison portion 15a executes the process of S181.

When the image comparison portion 15a determines that the blur degree difference is within the specific range, the image comparison portion 15a terminates the blur matching process shown in FIG. 13.

As shown in FIG. 3, when the blur matching process of S128 is completed, the image comparison portion 15a executes the process of S129. In S129, the image comparison portion 15a executes the process of matching the tones of the reference image and the target image whose degrees of blur have been matched in S128.

In S129, the image comparison portion 15a creates a gamma table that matches the histogram of the target image to the histogram of the reference image. Further, the image comparison portion 15a applies the created gamma table to the target image to match the tones of the reference image and the target image.

When the process of S129 is completed, the image comparison portion 15a terminates the preprocessing shown in FIG. 3.

As shown in FIG. 2, when the preprocessing of S102 is completed, the image comparison portion 15a determines the next processing according to whether or not it was determined that the reference image and the target image are different images in the preprocessing (S103).

When it was not determined that the reference image and the target image are different images, the image comparison portion 15a executes image comparison processing (S104). The image comparison process is processing for comparing the reference image and the target image subjected to the preprocessing of S102.

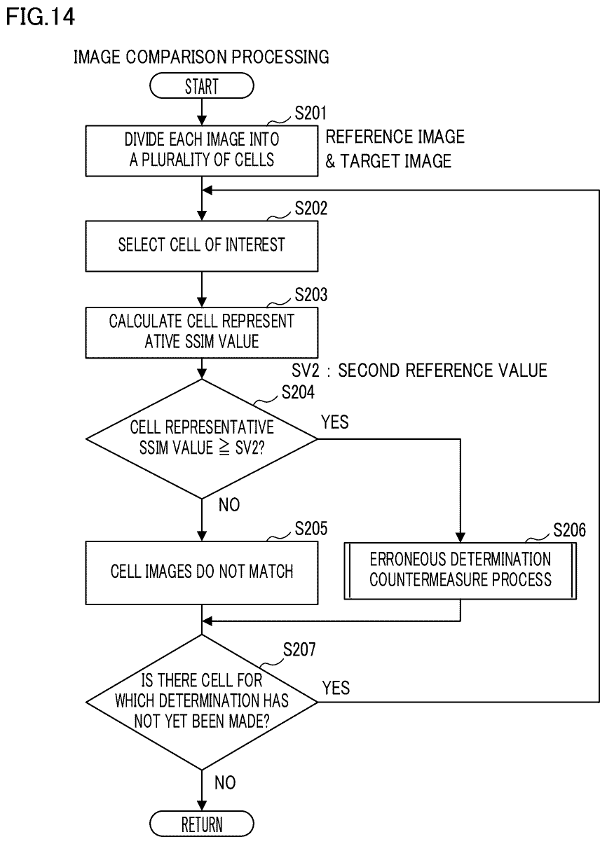

FIG. 14 is a flowchart of the image comparison processing shown in FIG. 2.

As shown in FIG. 14, the image comparison portion 15a divides each of the reference image and the target image subjected to the preprocessing of S102 into a plurality of cells (S201). Each of the plurality of cells is an area having a specific size.

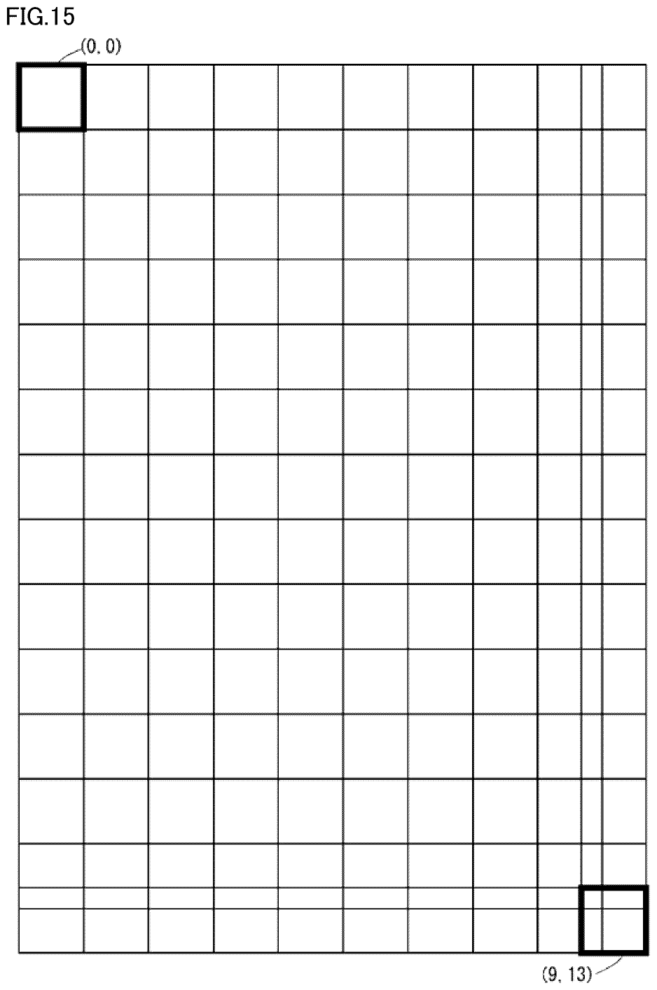

FIG. 15 shows an example of an image divided into the plurality of cells in the image comparison processing shown in FIG. 14.

For example, a case condition satisfies a first condition, a second condition, and a third condition indicated below. The first condition is that the size of the recording medium which is the source of each of the reference image and the target image is 210 mm×297 mm. The second condition is that the resolution is 75 dpi. Under the first condition and the second condition, the size of each of the reference image and the target image is 619 dots×875 dots. The third condition is that the size of each of the plurality of cells into which each of the reference image and the target image is divided is 64 dots×64 dots.

Under the case condition, the image comparison portion 15a divides each of the reference image and the target image into 10 horizontal cells and 14 vertical cells as shown in FIG. 15 (S201). Here, the size of each of the reference image and the target image is not an integer multiple of the size of each of the cells, either in the horizontal direction or in the vertical direction. In this case, the image comparison portion 15a sets the rightmost cell and the bottommost cell of each of the reference image and the target image to partially overlap their adjacent cells, respectively. The Xth cell from the left and Yth from the top is represented as cell (X−1, Y−1). For example, the leftmost and topmost cell is represented as cell (0, 0). The rightmost and bottommost cell is represented as cell (9, 13).

As shown in FIG. 14, when the process of S201 is completed, the image comparison portion 15a selects, as a cell of interest, one of the plurality of cells divided in S201 for which the determination as to whether or not the images match has not yet been made (S202).

In the following description, the image of the cell of interest in the reference image will be referred to as a reference cell image, and the image of the cell of interest in the target image will be referred to as a target cell image.

When the process of S202 is completed, the image comparison portion 15a calculates a cell representative SSIM value, which is an overall SSIM value of the reference cell image and the target cell image (S203).

Here, among the plurality of pixel SSIM values, values corresponding to all pixels in the reference cell image and the target cell image are referred to as a plurality of cell pixel SSIM values. For example, in S203, the image comparison portion 15a calculates an average value of the plurality of cell pixel SSIM values as the cell representative SSIM value.

When the process of S203 is completed, the image comparison portion 15a determines whether or not the cell representative SSIM value is equal to or greater than a predetermined second reference value (S204). For example, the second reference value is 0.9.

When the image comparison portion 15a determines that the cell representative SSIM value is not equal to or greater than the second reference value, the image comparison portion 15a determines that the reference cell image and the reference target image do not match (S205).

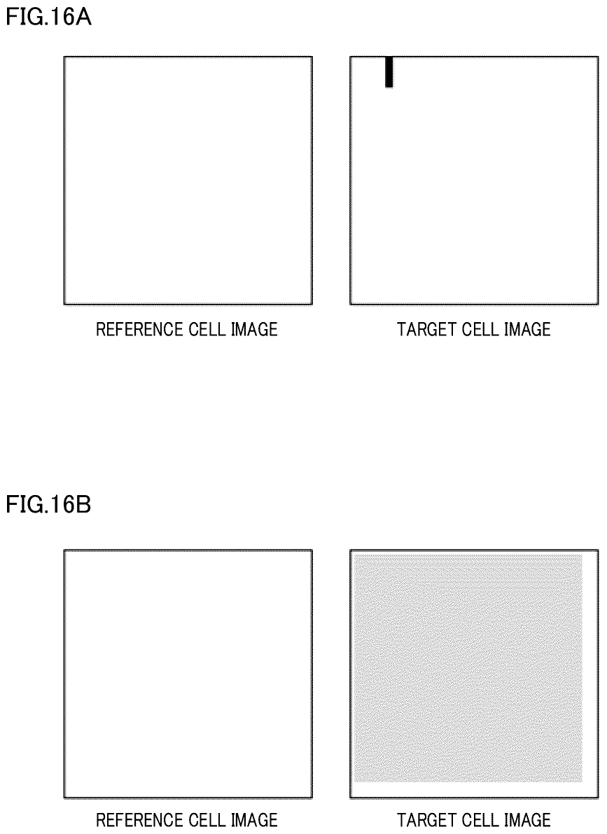

FIG. 16A shows an example of the reference cell image and the reference target image when the area of difference is narrow and the difference in pixel values in the area of difference is large. FIG. 16B shows an example of the reference cell image and the reference target image when the difference in pixel values in the area of difference is small and the area of difference is wide.

The cell representative SSIM value is an average value of the plurality of cell pixel SSIM values corresponding to all pixels in the reference cell image and the target cell image. Therefore, when there is an area of difference between the reference cell image and the target cell image, for example, the state shown in FIG. 16A or the state shown in FIG. 16B may occur, which may cause the cell representative SSIM value to be equal to or greater than the second reference value.

The state shown in FIG. 16A is a state in which the area of difference region is narrow and the difference in pixel values in the area of difference is large. The state shown in FIG. 16B is a state in which the difference in pixel values in the area of difference is small and the area of difference is wide.

Therefore, even when the cell representative SSIM value is equal to or greater than the second reference value, the reference cell image and the target cell image may not match.

As a case where the state shown in FIG. 16A occurs, for example, a foreign matter reading case shown below is conceivable. The foreign matter reading case is a case where, when at least one of the reference image and the target image is the read image read from a document by the reading device or an image generated based on the read image, a small-diameter foreign matter such as dust attached to the document is read by the reading device.

As shown in FIG. 14, when the image comparison portion 15a determines that the cell representative SSIM value is equal to or greater than the second reference value, the image comparison portion 15a executes an erroneous determination countermeasure process (S206). The erroneous determination countermeasure process is a process of reducing the possibility of erroneously determining that the reference cell image and the target cell image match.

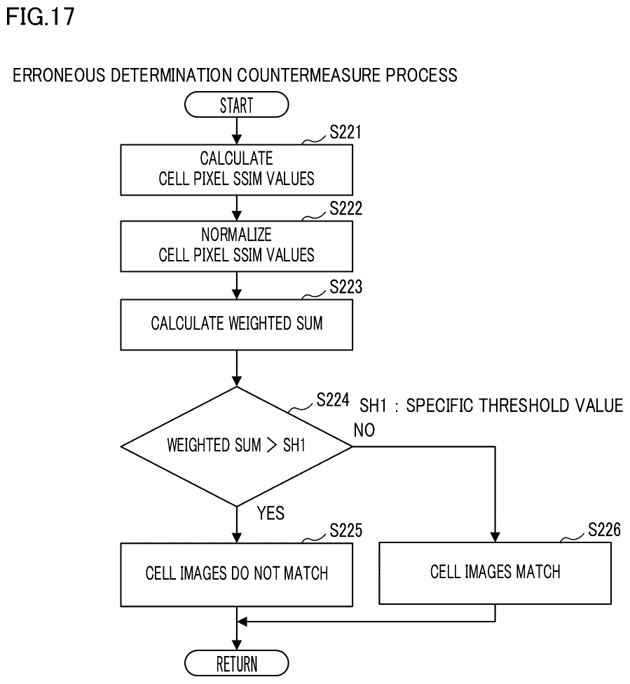

FIG. 17 is a flowchart of the erroneous determination countermeasure process shown in FIG. 14.

As shown in FIG. 17, the image comparison portion 15a calculates the plurality of cell pixel SSIM values which are the SSIM values of all the pixels in the reference cell image and the target cell image (S221).

Next, the image comparison portion 15a normalizes each of the plurality of cell pixel SSIM values to a value in the range of 0 to 255 (S222). Specifically, the image comparison portion 15a rounds a value obtained by multiplying each of the cell pixel SSIM values by 255 to an integer.

Here, among the plurality of normalized cell pixel SSIM values, one or more values that belong to a predetermined specific range are referred to as first count target SSIM values.

When the process of S222 is completed, the image comparison portion 15a calculates a weighted sum of the number of pixels corresponding to the first count target SSIM values in the reference cell image and the target cell image (S223). In S223, the image comparison portion 15a identifies the first count target SSIM values among the plurality of cell pixel SSIM values. Further, the image comparison portion 15a adds up the number of pixels for each level of the first count target SSIM values with a weight determined for each level of the first count target SSIM values to calculate the weighted sum.

Specifically, the image comparison portion 15a calculates the weighted sum based on the equation (2) below:

$$\\ \begin{matrix}{\sum }_{n = 0}^{200} ( 200 - n ) {x}_{n} & ( 2 )\end{matrix}$$

In Equation (2), n is the level of the first count target SSIM values. xₙ is the number of pixels whose level of the first count target SSIM values is n. That is, xₙ is the number of pixels for each level of the normalized cell pixel SSIM values within the specific range.

The weighted sum calculated based on Equation (2) is a value obtained by adding up the number of pixels for each level of the first count target SS IM values with a weight determined for each level of the first count target SSIM values. (200−n) in Equation (2) is a weighting factor determined for each level of the first count target SSIM values.

It is noted that the first count target SSIM value being 200 corresponds to the cell pixel SSIM value before normalization being approximately 0.8. In an image area where the cell pixel SSIM value before normalization exceeds 0.8, the above-described characteristics that cause erroneous determination hardly appear. Therefore, among the plurality of normalized cell pixel SSIM values, the pixels corresponding to the values that belong to the range of 201 to 255 are excluded from the calculation target of the weighted sum.

In Equation (2), the weight determined for each level of the first count target SSIM values is represented by a moment with 200 as the origin in the first count target SS IM values. For example, in Equation (2), the weights when the first count target SSIM values are 0, 100, and 200 are 200, 100, and 0, respectively.

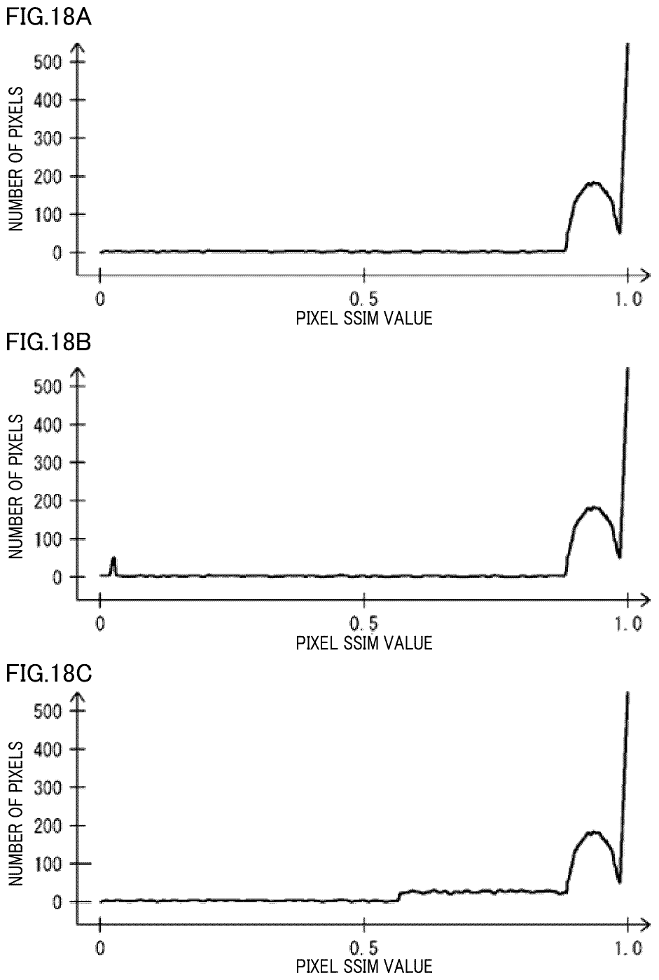

FIG. 18A to FIG. 18C show examples of a histogram showing the frequency of each of the pixel SSIM values of all the pixels of the reference cell image and the target cell image. FIG. 18A shows an example of a histogram when there is almost no difference between the reference cell image and the target cell image. FIG. 18B shows an example of a histogram when the area of difference between the reference cell image and the target cell image is narrow and the difference in pixel values in the area of difference is large. FIG. 18C shows an example of a histogram when the difference in pixel values in the area of difference between the reference cell image and the target cell image is small and the area of difference is wide. The situation in which the histogram of FIG. 18C is obtained is, for example, the situation shown in FIG. 16B.

In the histogram shown in FIG. 18A, the pixel SSIM values of most pixels are concentrated at 1 or a value near 1. Therefore, the weighted sum calculated based on Equation (2) is a relatively small value.

In the histogram shown in FIG. 18B, the pixel SSIM values of many pixels are concentrated at 1 or a value near 1, but there are also a few pixels corresponding to the cell pixel SSIM values of 0 or in the vicinity of 0. Therefore, the weighted sum calculated based on Equation (2) is a relatively large value.

In the histogram shown in FIG. 18C, the pixel SSIM values of many pixels are 1 or values in the vicinity of 1, but there are also some number of pixels whose pixel SSIM values correspond to, for example, 0.588 to 0.863. Therefore, the weighted sum calculated based on Equation (2) is a relatively large value.

As shown in FIG. 17, when the process of S223 is completed, the image comparison portion 15a determines whether or not the weighted sum calculated in S223 exceeds a predetermined specific threshold value (S224). The specific threshold value is a threshold value for determining whether or not the reference cell image and the target cell image match. The specific threshold value can be set to any value such as 6000.

When the image comparison portion 15a determines that the weighted sum exceeds the specific threshold value, the image comparison portion 15a determines that the reference cell image and the target cell image do not match (S225).

When the image comparison portion 15a determines that the weighted sum does not exceed the specific threshold value, the image comparison portion 15a determines that the reference cell image and the target cell image match (S226).

When the process of S225 or S226 is completed, the image comparison portion 15a terminates the erroneous determination countermeasure process shown in FIG. 17.

As shown in FIG. 14, when the process of S205 or S206 is completed, the image comparison portion 15a determines whether or not there is a cell for which the matching determination in S205, S225 or S226 has not yet been made among the plurality of cells divided in S201 (S207). The matching determination is the determination of whether or not the reference cell image and the target cell image match.

When the image comparison portion 15a determines that there is a cell for which the matching determination has not yet been made among the plurality of cells, the image comparison portion 15a executes the process of S202.

When the image comparison portion 15a determines that there is no cell for which the matching determination has not yet been made among the plurality of cells, the image comparison portion 15a terminates the image comparison processing shown in FIG. 14.

As shown in FIG. 2, when it is determined in the preprocessing that the reference image and the target image are different images, or when the image comparison processing of S104 is completed, the image comparison portion 15a executes notification processing (S105). The notification processing is processing for notifying the result of the comparison between the reference image and the target image.

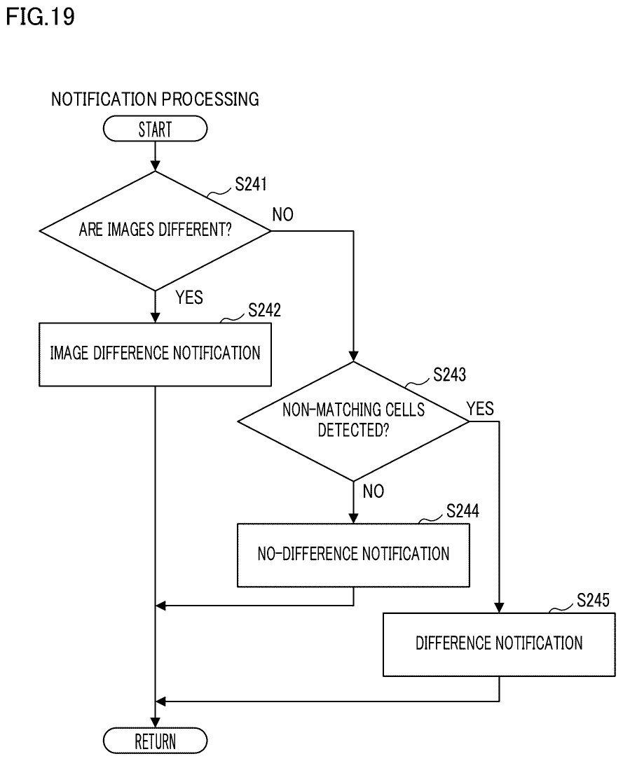

FIG. 19 is a flowchart of the notification processing shown in FIG. 2.

As shown in FIG. 19, the image comparison portion 15a determines whether or not the reference image and the target image were determined to be different images in the preprocessing (S241).

When the reference image and the target image were determined to be different images, the image comparison portion 15a outputs an image difference notification indicating that the reference image and the target image are different images through the display portion 12 or the communication portion 13 (S242).

When the reference image and the target image were not determined to be different images, the image comparison portion 15a determines whether or not non-matching cells were detected in the image comparison processing in S104 (S243).

When the process of S205 or S225 is executed even once in the image comparison processing, the image comparison portion 15a determines that a non-matching cell was detected. On the other hand, when the processes of S205 and S225 were never executed in the image comparison processing, the image comparison portion 15a determines that no non-matching cell was detected.

When the image comparison portion 15a determines that no non-matching cell was detected, the image comparison portion 15a outputs a no-difference notification indicating that there is no difference between the reference image and the target image through the display portion 12 or the communication portion 13 (S244).

When the image comparison portion 15a determines that a non-matching cell was detected, the image comparison portion 15a outputs a difference notification through the display portion 12 or the communication portion 13 (S245). The difference notification is a notification indicating that there is a difference between the reference image and the target image and indicating the position of the non-matching cell. Here, the non-matching cell is the cell of interest that was selected when the process of S205 or S225 was executed.

When the process of S242, S244, or S245 is completed, the image comparison portion 15a terminates the notification processing shown in FIG. 14.

As shown in FIG. 2, when the notification processing of S105 is completed, the image comparison portion 15a terminates the main processing shown in FIG. 2.

As described above, the image comparison apparatus 10 executes the processes of S203 to S206 when there is a difference in some pixel values between the reference cell image and the target cell image. In S203 to S206, the image comparison apparatus 10 does not always determine that the reference cell image and the target cell image do not match.

In S203 to S206, the image comparison apparatus 10 determines whether or not the reference cell image and the target cell image match, based on the cell representative SSIM values of the entire reference cell image and the entire target cell image (S203 to S206). Thus, when at least one of the reference cell image and the target cell image is the read image read from a document by the reading device or an image generated based on the read image, the accuracy of detecting the difference between the two documents corresponding to the reference cell image and the target cell image can be improved.

Even when the cell representative SSIM value is equal to or greater than the second reference value (YES in S204), the image comparison apparatus 10 determines that the reference cell image and the target cell image do not match if the weighted sum exceeds the specific threshold value (S224 and S225). Thus, when the reference cell image and the target cell image are similar to each other but are not substantially identical to each other, the possibility of erroneously determining that the reference cell image and the target cell image match is reduced.

When the cell representative SSIM value is less than the second reference value (NO in S204), the image comparison apparatus 10 determines that the reference cell image and the target cell image do not match (S205). Thus, when the reference cell image and the target cell image are not similar to each other, the possibility of erroneously determining that the reference cell image and the target cell image match is reduced.

When the cell representative SSIM value is equal to or greater than the second reference value (YES in S204), the image comparison apparatus 10 determines that the reference cell image and the target cell image match on the condition that the weighted sum is equal to or less than the specific threshold value (S224, S226). Thus, when the reference cell image and the target cell image are identical or substantially identical, the possibility of erroneously determining that the reference cell image and the target cell image do not match is reduced.

The image comparison apparatus 10 compares the target image from which the shadow has been removed by the shadow removal process of S123 with the reference image (S104). Thus, even when the target image includes a shadow caused by reading by the reading device, the accuracy of detecting the difference between the two documents corresponding to the reference image and the target image can be improved.

When the histogram showing the number of pixels for each luminance of the difference absolute value image includes the plurality of protruding portions (YES in S165), the image comparison apparatus 10 generates the mask image (S166). The mask image is an image for extracting pixels within a luminance range that constitute the target protruding portion, for each of the target protruding portions other than the first protruding portion 31 with the lowest luminance among the plurality of protruding portions.

Further, the image comparison apparatus 10 generates the shadow mask image by enlarging the mask image to the same size as the reference image (S167). The first protruding portion 31 with the lowest luminance represents the difference in luminance between the entire reduced reference image and the entire reduced target image. The appropriate shadow mask image is generated by the processes of S166 and S167.

The image comparison apparatus 10 generates the shadow mask image based on the reduced reference image and the reduced target image (S161 to S167). Thus, at least part of the noise included in each of the reference image and the target image may be removed from the reduced reference image and the reduced target image. As a result, the possibility that noise included in each of the reference image and the target image affects the shadow mask image is reduced.

In addition, the shadow mask image is generated based on the reduced reference image and the reduced target image which are relatively small in size (S161 to S167). Thus, the burden of image processing for generating the shadow mask image is reduced, and the speed of generating the shadow mask image is improved.

The image comparison apparatus 10 generates the difference absolute value image based on the blurred reduced target image and the blurred reduced reference image (S162 to S163). This reduces the possibility that a slight difference in pixel position between the reduced reference image and the reduced target image affects the shadow mask image. It is noted that the image comparison apparatus 10 may generate the difference absolute value image based on an unblurred reduced target image and an unblurred reduced reference image.

The image comparison apparatus 10 compares the reference image and the target image whose difference in the degree of blur is reduced to within a specific range by the blur matching process of S128 (S104). Thus, even when at least one of the reference image and the target image includes blur caused by reading by the reading device, the accuracy of detecting the difference between the two documents corresponding to the reference image and the target image is improved.

The image comparison apparatus 10 performs a Laplacian transform on the reference image and the target image to generate the transformed reference image and the transformed target image. Further, the image comparison apparatus 10 calculates the variance values of the transformed reference image and the transformed target image as the degrees of blur of the reference image and the target image (S181). This makes it possible to appropriately calculate the degrees of blur of the reference image and the target image.

It is noted that the image comparison apparatus 10 may calculate a value of the degree of variation other than the variance value as the degree of blur for each of the transformed reference image and the transformed target image. For example, the image comparison apparatus 10 may calculate the standard deviation of each of the transformed reference image and the transformed target image as the degree of blur of each of the transformed reference image and the transformed target image.

The image comparison apparatus 10 adds blur, by applying a specific Gaussian filter, to one of the reference image and the target image that has a smaller degree of blur (S183). However, a filter other than the Gaussian filter may be employed as a filter for adding blur to an image.

The image comparison apparatus 10 repeatedly applies the same Gaussian filter to one of the reference image and the target image until the difference in the degree of blur between the reference image and the target image falls within a specific range (S182 and S183). However, the image comparison apparatus 10 may change the Gaussian filter used in S183 for each process of S183. [First Application Example]

A first application example of the first embodiment will be described below. In this application example, when the cell representative SSIM value is equal to or greater than the second reference value (YES in S204), the image comparison portion 15a determines that the reference cell image and the target cell image do not match if one of the plurality of cells satisfies a first specific condition.

Here, among the plurality of cell pixel SSIM values, one or more values that belong to a specific range below the second reference value are referred to as second count target SSIM values. In this application example, the image comparison portion 15a identifies the second count target SSIM values among the plurality of cell pixel SSIM values.

The first specific condition is that the number of pixels corresponding to the second count target SSIM values in the reference cell image and the target cell image exceeds a predetermined specific number of pixels. For example, the specific range includes a first specific range in the vicinity of 0 and a second specific range of 0.588 to 0.863 (see FIG. 18B and FIG. 18C).

In the first application example, when the area of difference between the reference cell image and the target cell image is narrow and the difference in pixel values in the area of difference is large as shown in, for example, FIG. 16A, the possibility of erroneously determining that the reference cell image and the target cell image match is reduced. Similarly, when the difference in pixel values in the area of difference between the reference cell image and the target cell image is small and the area of difference is wide as shown in, for example, FIG. 16B, the possibility of erroneously determining that the reference cell image and the target cell image match is reduced.

### Second Application Example

A second application example of the first embodiment will be described below.

In S163 of this application example, the image comparison portion 15a generates, as the difference absolute value image, an image showing the absolute value of the difference in each pixel between the reference image and the target image which have undergone a rotation process of S122. In this application example, the image comparison portion 15a employs the mask image generated in S166 as the shadow mask image.

In this application example, the image comparison apparatus 10 generates the difference absolute value image showing the absolute value of the difference in each pixel between the target image and the reference image (S163). Further, when the histogram showing the number of pixels for each luminance of the difference absolute value image includes the plurality of protruding portions, the image comparison apparatus 10 generates, as the shadow mask image, the mask image for extracting the pixels in a luminance range constituting the target protruding portion. An appropriate shadow mask image is thereby generated.

In the present application, the image comparison apparatus 10 may blur the target image and the reference image by a specific method similar to the process of S162. In this case, the image comparison apparatus 10 generates the difference absolute value image based on the blurred target image and the blurred reference image. This reduces the possibility that a slight difference in pixel position between the reference image and the target image affects the shadow mask image.

### Second Embodiment

An image comparison apparatus according to a second embodiment of the present disclosure has the same configuration as that of the image comparison apparatus 10 according to the first embodiment (see FIG. 1). In the following description, the image comparison apparatus according to the second embodiment will be referred to as a second image comparison apparatus.

In the following description, among the constituent elements of the second image comparison apparatus, the same constituent elements as those of the image comparison apparatus 10 are denoted by the same reference numerals as those of the image comparison apparatus 10.

The operations of the second image comparison apparatus are the same as those of the image comparison apparatus 10 according to the first embodiment, except for the operations described below.

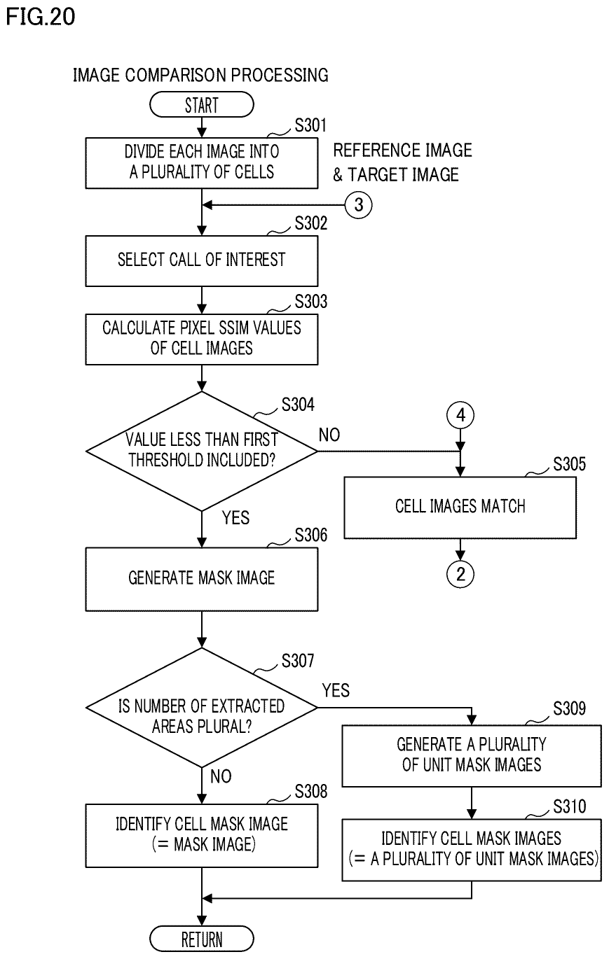

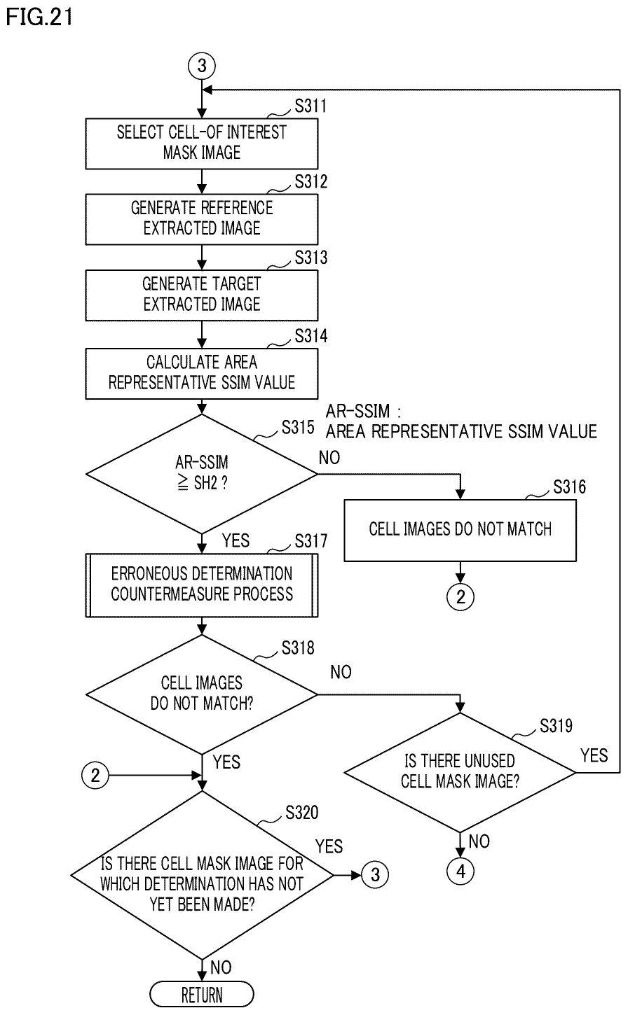

FIG. 20 and FIG. 21 are an example of a flowchart of the image comparison processing of S104 shown in FIG. 2. The example shown in FIG. 20 and FIG. 21 differs from the example shown in FIG. 14. FIG. 20 is a flowchart of a first part of the image comparison processing. FIG. 21 is a flowchart of a latter part of the image comparison processing. The latter part is a part following the first part.

The second image comparison apparatus executes the image comparison processing shown in FIG. 20 and FIG. 21 instead of the image comparison processing shown in FIG. 14.

As shown in FIG. 20 and FIG. 21, the image comparison portion 15a divides each of the reference image and the target image subjected to the preprocessing of S102 into a plurality of cells (S301). The process of step S301 is similar to that of S201 in FIG. 14.

When the process of S301 is completed, the image comparison portion 15a selects, as the cell of interest, one of the plurality of cells divided in S301 for which the determination as to whether or not the images match has not yet been made (S302).

When the process of S302 is completed, the image comparison portion 15a calculates the plurality of pixel SSIM values for all the pixels in the reference cell images of the reference image and the target cell images of the target image (S303).

When the process of S303 is completed, the image comparison portion 15a determines whether or not the plurality of pixel SS IM values calculated in S303 include a value less than a specific first threshold value (S304). The first threshold value in S304 is, for example, 0.8.

When the image comparison portion 15a determines that the plurality of pixel SS IM values calculated in S303 do not include any value less than the specific threshold value, the image comparison portion 15a determines that the reference cell image and the target cell image match with respect to the cell of interest (S305).

When the image comparison portion 15a determines that the plurality of pixel SSIM values calculated in S303 include a value less than the specific threshold value, the image comparison portion 15a generates a mask image (S306). The mask image is an image for extracting pixels corresponding to values less than the specific threshold value among the plurality of pixel SSIM values.

When the process of S306 is completed, the image comparison portion 15a determines whether or not the number of extracted areas extracted by the mask image generated in S306 is plural (S307).

When the image comparison portion 15a determines that the number of the extracted areas is not plural, the image comparison portion 15a identifies the one mask image generated in S306 as a cell mask image for the cell of interest (S308).

When the image comparison portion 15a determines that the number of the extracted areas is plural, the image comparison portion 15a decomposes the mask image generated in S306 to generate a plurality of unit mask images corresponding to the plurality of extracted areas (S309).

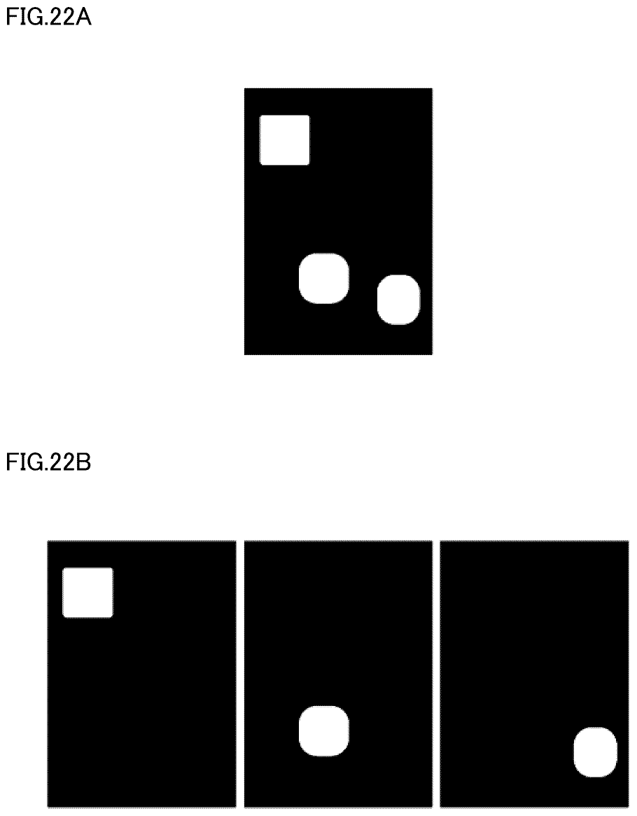

FIG. 22A shows an example of the mask image when the number of extracted areas extracted in the image comparison processing shown in FIG. 20 and FIG. 21 is plural. FIG. 22B shows an example of three unit mask images decomposed from the mask image shown in FIG. 22A.

For example, when the mask image shown in FIG. 22A is generated in S306, the number of extracted areas is three. In this case, the image comparison portion 15a generates the three unit mask images shown in FIG. 22B in the process of S309.

As shown in FIG. 20 and FIG. 21, when the process of S309 is completed, the image comparison portion 15a identifies the plurality of unit mask images generated in S309 as the cell mask images for the cell of interest (S310).

When the process of S308 or S310 is completed, the image comparison portion 15a selects one of the cell mask images identified in S308 or S310 that has not yet been used for the masking process as a cell-of-interest mask image (S311).

When the process of S311 is completed, the image comparison portion 15a generates a reference extracted image based on the cell-of-interest mask image and the reference cell image (S312). The reference extracted image is an image of the extracted area extracted from the reference cell image with the cell-of-interest mask image. That is, the image comparison portion 15a executes a masking process on the reference image using the cell-of-interest mask image.

When the process of S312 is completed, the image comparison portion 15a generates a target extracted image based on the cell-of-interest mask image and the target cell image (S313). The target extracted image is an image of the extracted area extracted from the target image with the cell-of-interest mask image. That is, the image comparison portion 15a executes a masking process on the target cell image using the cell-of-interest mask image.

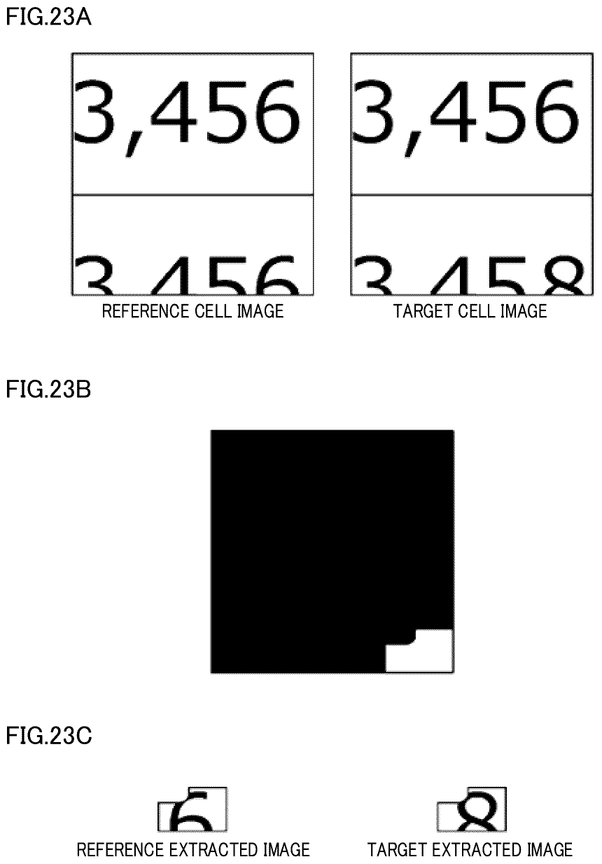

FIG. 23A shows an example of the reference cell image and the target cell image generated in the image comparison processing shown in FIG. 20 and FIG. 21. FIG. 23B shows an example of the cell mask image applied to the reference cell image and the target cell image shown in FIG. 23A. FIG. 23C shows an example of the reference extracted image and the target extracted image generated by applying the cell mask image shown in FIG. 23B to the reference cell image and the target cell image shown in FIG. 23A.

For example, in the processes of S312 and S313, the image comparison portion 15a applies the cell mask image shown in FIG. 23B as the cell-of-interest mask image to the reference cell image and the target cell image shown in FIG. 23A. The reference extracted image and the target extracted image shown in FIG. 23C are thereby generated. As shown in FIG. 23C, the reference extracted image and the target extracted image have a size equal to or smaller than the size of a single cell.

As shown in FIG. 20 and FIG. 21, when the process of S313 is completed, the image comparison portion 15a calculates an area representative SSIM value, which is an SSIM value of the entire reference extracted image and the entire target extracted image generated in S312 and S313 (S314). For example, in S314, the image comparison portion 15a calculates the average value of the values corresponding to all pixels in the reference extracted image and the target extracted image among the plurality of pixel SS IM values as the area representative SSIM value.

When the process of S314 is completed, the image comparison portion 15a determines whether or not the area representative SSIM value calculated in S314 is equal to or greater than a specific second threshold value (S315). The second threshold value is, for example, 0.9.

When the image comparison portion 15a determines that the area representative SSIM value is not equal to or greater than the second threshold value, the image comparison portion 15a determines that the reference cell image and the target cell image do not match (S316). That is, when the image comparison portion 15a determines that the reference extracted image and the target extracted image do not match, the image comparison portion 15a determines that the reference cell image and the target cell image do not match.

When the image comparison portion 15a determines that the area representative SSIM value is equal to or greater than the second threshold value, the image comparison portion 15a executes an erroneous determination countermeasure process corresponding to the process of S206 (S317).

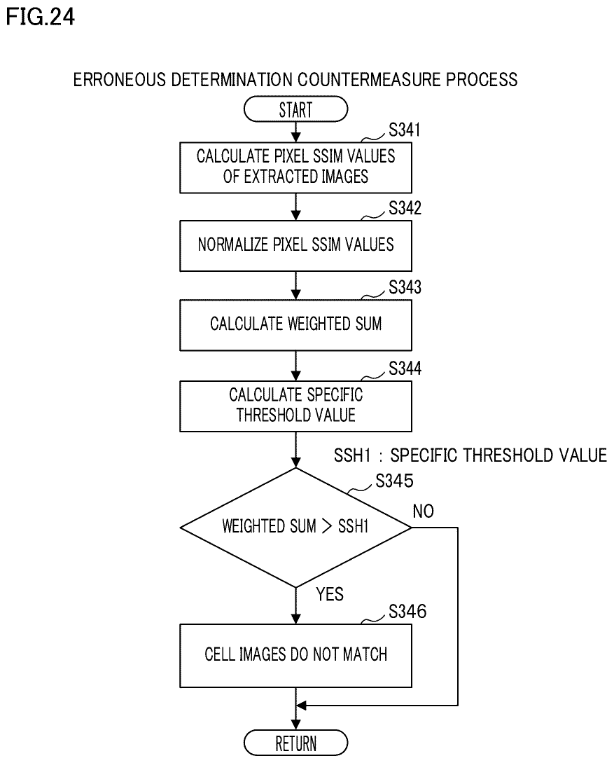

FIG. 24 is a flowchart of the erroneous determination countermeasure process shown in FIG. 21.

As shown in FIG. 24, the image comparison portion 15a calculates a plurality of area pixel SSIM values which are the SSIM values of all the pixels in the reference extracted image and the target extracted image generated in S312 and S313 (S341).

Next, the image comparison portion 15a normalizes the plurality of area pixel SSIM values calculated in S341 to values in the range of 0 to 255 (S342). The process of S342 is the same as the process of S222. The plurality of normalized area pixel SSIM values are obtained by the process of S342.

When the process of S342 is completed, the image comparison portion 15a calculates the weighted sum by applying the plurality of area pixel SS IM values obtained in S342 to Equation (1) (S343).

When the process of S343 is completed, the image comparison portion 15a calculates the specific threshold value based on Equation (3) (S344). It is noted that, in S224 and S344, the specific threshold value is a value for the same purpose.

$$\\ \begin{matrix}{M}_{1} \times \frac{{M}_{3}}{{M}_{2}} & ( 3 )\end{matrix}$$

In Equation (3), M₁ is the specific threshold value when the number of pixels of the reference extracted image is assumed to be equal to the number of pixels of the cell. M₂ is the number of pixels of the cell. M₃ is the number of pixels of the reference extracted image. For example, an arbitrary value such as 6000 is set as M₁. For example, when the cell size is 64 dots×64 dots, M₂ is 4096.

When the process of S344 is completed, the image comparison portion 15a determines whether or not the weighted sum calculated in S343 exceeds the specific threshold value (S345).

When the image comparison portion 15a determines that the weighted sum exceeds the specific threshold value, the image comparison portion 15a determines that the reference cell image and the target cell image do not match (S346). That is, when the image comparison portion 15a determines that the reference extracted image and the target extracted image do not match, the image comparison portion 15a determines that the reference cell image and the target cell image do not match.

When the image comparison portion 15a determines in S345 that the weighted sum does not exceed the specific threshold value, or when the process of S346 is terminated, the image comparison portion 15a terminates the erroneous determination countermeasure process shown in FIG. 24.

As shown in FIG. 20 and FIG. 21, when the erroneous determination countermeasure process of S317 is completed, the image comparison portion 15a determines whether or not it was determined in S317 that the reference cell image and the target cell image do not match (S318).

When it was determined that the reference cell image and the target cell image do not match, the image comparison portion 15a determines whether or not the cell mask images identified in S308 or S310 include an image that has not yet been used for the masking process (S319).

When the image comparison portion 15a determines that the cell mask images include an image that has not yet been used for the masking process, the image comparison portion 15a executes the process of S311.

When the image comparison portion 15a determines that the cell mask images do not include an image that has not yet been used for the masking process, the image comparison portion 15a determines that the reference cell image and the target cell image match (S305).

When it was determined in S318 that the reference cell image and the target cell image do not match, or when the process of S305 or S316 is completed, the image comparison portion 15a executes the process of S320. In S320, the image comparison portion 15a determines whether or not the plurality of cells divided in S301 include a cell for which the match determination in S305, S316, or S346 has not yet been made (S320).

When the image comparison portion 15a determines that the plurality of cells include a cell for which the match determination has not yet been made, the image comparison portion 15a executes the process of S302.

When the image comparison portion 15a determines that the plurality of cells do not include a cell for which the match determination has not yet been made, the image comparison portion 15a terminates the image comparison processing shown in FIG. 20 and FIG. 21.

As described above, when there is a difference in some pixel values between the reference extracted image and the target extracted image, the second image comparison device does not necessarily determine that the reference extracted image and the target extracted image do not match.

In S312 to S317, the second image comparison apparatus determines whether or not the reference extracted image and the target extracted image match, based on the area representative SSIM value of the reference extracted image and the target extracted image. Thus, when at least one of the reference extracted image and the target extracted image is the read image read from a document by the reading device or an image generated based on the read image, the accuracy of detecting the difference between the two documents corresponding to the reference extracted image and the target extracted image can be improved.

Even when the area representative SSIM value is equal to or greater than the specific second threshold value (YES in S315), the second image comparison apparatus determines that the reference extracted image and the target extracted image do not match when the weighted sum exceeds the specific threshold value (S345 and S346). Thus, when the reference extracted image and the target extracted image are similar to each other but are not substantially identical to each other, the possibility of erroneously determining that the reference extracted image and the target extracted image match is reduced.

The second image comparison apparatus extracts the reference extracted image and the target extracted image from the reference cell image and the target cell image, respectively (S312, S313). The reference extracted image and the target extracted image are constituted by pixels corresponding to the values less than the specific threshold value among the plurality of pixel SSIM values. Further, when the second image comparison apparatus determines that the reference extracted image and the target extracted image do not match, the image comparison apparatus determines that the reference cell image and the target cell image do not match (S315, S316, S345, and S346). Thus, when the reference extracted image and the target extracted image are not similar to each other, the possibility of erroneously determining that the reference cell image and the target cell image match is reduced.

When the area representative SSIM value is less than the specific second threshold value, the second image comparison apparatus determines that the reference extracted image and the target extracted image are not similar to each other (S315 and S316). Thus, when the reference extracted image and the target extracted image are not similar to each other, the possibility of erroneously determining that the reference extracted image and the target extracted image match is reduced.

When the area representative SSIM value is equal to or greater than the second threshold value, the second image comparison apparatus determines that the reference extracted image and the target extracted image match on the condition that the weighted sum is equal to or less than the specific threshold value (S315 and S316). Thus, when the reference extracted image and the target extracted image are identical or substantially identical, the possibility of erroneously determining that the reference extracted image and the target extracted image do not match is reduced.

### Third Application Example

A third application example, which is an application example of the second embodiment, will be described below.

In this application example, when the area representative SSIM value is equal to or greater than the second threshold value (YES in S315), the second image comparison apparatus determines that the reference extracted image and the target extracted image do not match if the reference extracted image and the target extracted image satisfy a second specific condition.

Here, among the plurality of area pixel SSIM values, one or more values that belong to a specific range below the second threshold value are referred to as third count target SSIM values. The second specific condition is that the number of pixels corresponding to the third count target SS IM values in the reference extracted image and the target extracted image exceeds a predetermined specific number of pixels. For example, the specific range includes a first specific range in the vicinity of 0 and a second specific range of 0.588 to 0.863 (see FIG. 18B and FIG. 18C).

In the third application example, when the area of difference between the reference extracted image and the target extracted image is narrow and the difference in pixel values in the area of difference is large as shown in, for example, FIG. 16A, the possibility of erroneously determining that the reference extracted image and the target extracted image match is reduced. Similarly, when the difference in pixel values in the area of difference between the reference extracted image and the target extracted image is small and the area of difference is wide as shown in, for example, FIG. 16B, the possibility of erroneously determining that the reference extracted image and the target extracted image match is reduced.

[Postscript]

In each of the above-described embodiments, the image comparison apparatus of the present disclosure is configured by a PC. However, the image comparison apparatus of the present disclosure may be configured by a computer other than a PC, such as a multifunction peripheral (MFP).

In each of the above-described embodiments, the image comparison apparatus of the present disclosure is configured by a single computer. However, the image comparison apparatus of the present disclosure may be configured by a plurality of computers.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image comparison apparatus comprising an image comparison portion configured to compare a first image with a second image, wherein
the image comparison portion calculates a plurality of pixel SSIM values which are SSIM values of all pixels of the first image and the second image and a representative SSIM value which is an overall SSIM value of the first image and the second image,
the image comparison portion further determines that the first image and the second image are different images when the representative SSIM value is less than a first threshold value,
the image comparison portion further identifies one or more count target SSIM values that belong to a specific range below the first threshold value among the plurality of pixel SS IM values when the representative SSIM value is equal to or greater than the first threshold value,
the image comparison portion further adds up a number of pixels for each level of the one or more count target SSIM values in the first image and the second image with a weight according to each level of the one or more count target SSIM values to calculate a weighted sum, and
the image comparison portion further determines that the first image and the second image do not match when the weighted sum exceeds a second threshold value.

2. The image comparison apparatus according to claim 1, wherein the image comparison portion determines that the first image and the second image do not match when the representative SSIM value is less than the first threshold value.

3. The image comparison apparatus according to claim 1, wherein the image comparison portion determines that the first image and the second image match when the representative SSIM value is equal to or greater than the first threshold value and a number of pixels corresponding to the one or more count target SSIM values is equal to or less than the second threshold value.

4. The image comparison apparatus according to claim 1, wherein
the image comparison portion calculates the plurality of pixel SSIM values for all pixels of a first original image including the first image and a second original image including the second image,
the image comparison portion further extracts, from the first original image and the second original image, images composed of pixels corresponding to values less than a third threshold value among the plurality of pixel SSIM values as the first image and the second image, and
the image comparison portion further determines that the first original image and the second original image do not match when the image comparison portion determines that the extracted first image and the extracted second image do not match.

5. An image comparison apparatus comprising an image comparison portion configured to compare a first image with a second image, wherein
the image comparison portion calculates a plurality of pixel SSIM values which are SSIM values of all pixels of the first image and the second image and a representative SSIM value which is an overall SSIM value of the first image and the second image,
the image comparison portion further determines that the first image and the second image are different images when the representative SSIM value is less than a first threshold value,
the image comparison portion further identifies one or more count target SSIM values that belong to a specific range below the first threshold value among the plurality of pixel SS IM values when the representative SSIM value is equal to or greater than the first threshold value, and
the image comparison portion further determines that the first image and the second image do not match when a number of pixels corresponding to the one or more count target SSIM values in the first image and the second image exceeds a second threshold value.

6. The image comparison apparatus according to claim 5, wherein the image comparison portion determines that the first image and the second image do not match when the representative SSIM value is less than the first threshold value.

7. The image comparison apparatus according to claim 5, wherein the image comparison portion determines that the first image and the second image match when the representative SSIM value is equal to or greater than the first threshold value and a number of pixels corresponding to the one or more count target SSIM values is equal to or less than the second threshold value.

8. The image comparison apparatus according to claim 5, wherein
the image comparison portion calculates the plurality of pixel SSIM values for all pixels of a first original image including the first image and a second original image including the second image,
the image comparison portion further extracts, from the first original image and the second original image, images composed of pixels corresponding to values less than a third threshold value among the plurality of pixel SSIM values as the first image and the second image, and
the image comparison portion further determines that the first original image and the second original image do not match when the image comparison portion determines that the extracted first image and the extracted second image do not match.

9. A storage medium of an image comparison program for causing a computer to execute a process executed by the image comparison apparatus according to claim 1.

10. A storage medium of an image comparison program for causing a computer to execute a process executed by the image comparison apparatus according to claim 5.
